(19) United States
(12) Patent Application Publication
(10) Pub. No.: US 2020/0243839 A1
(43) Pub. Date: Jul. 30, 2020

(54) POSITIVE ELECTRODE ACTIVE MATERIAL, MANUFACTURING METHOD FOR THE SAME, AND RECHARGEABLE BATTERY

(71) Applicant: FUJITSU LIMITED, Kawasaki-shi (JP)

(72) Inventors: Jiyunichi Iwata, Sagamihara (JP); Kenji Homma, Atsugi (JP)

(73) Assignee: FUJITSU LIMITED, Kawasaki-shi (JP)

(21) Appl. No.: 16/716,566

(22) Filed: Dec. 17, 2019

(30) Foreign Application Priority Data
Jan. 24, 2019 (JP) 2019-009854

(51) Int. Cl. H01M 4/131; H01M 4/58; H01M 4/1391; H01M 10/0525; H01M 4/525; H01M 10/44

(52) U.S. Cl. CPC H01M 4/131; H01M 4/58; H01M 4/1391; H01M 2300/0065; H01M 4/525; H01M 10/44; H01M 10/0525

(57) ABSTRACT

A positive electrode active material for lithium ion rechargeable battery is disclosed. The positive electrode active material is represented by composition formula: Li_{2-X}Mg_{X}CoP₂O₇, wherein X is equal to or greater than 0.01 and equal to or smaller than 0.2.

### CROSS-REFERENCE TO RELATED APPLICATION

This application is based upon and claims the benefit of priority of the prior Japanese Patent Application No. 2019-9854, filed on Jan. 24, 2019, the entire contents of which are incorporated herein by reference.

### FIELD

The embodiment discussed herein is related to a positive electrode active material, a manufacturing method for the same, and a rechargeable battery.

### BACKGROUND

In recent years, there has been a demand for improvements in performance of a rechargeable (or secondary) battery, particularly a lithium ion rechargeable battery, used as an independent power source for Internet of things (IoT) sensors.

In order to improve the performance of a lithium ion rechargeable battery, various studies have been carried out on materials used for the positive electrode, the negative electrode, and the electrolyte of the battery.

The above-mentioned lithium ion rechargeable battery includes a positive electrode active material that causes an oxidation-reduction reaction in a positive electrode, and a negative electrode active material that causes an oxidation-reduction reaction in a negative electrode. As a result of the chemical reaction, the positive electrode active material and the negative electrode active material release energy. By extracting the released energy as electric energy, the lithium ion rechargeable battery enables its function as a battery.

For example, a positive electrode active material containing a lithium combined metal oxide represented by the formula of LiMgₓM₁₋ₓPO₄ (0.5<x<0.75, M is cobalt or nickel) is proposed to obtain a large discharge capacity and excellent large current discharge characteristics (for example, see Japanese Laid-open Patent Publication No. 2002-358965).

For example, lithium cobalt pyrophosphate (Li₂CoP₂O₇, hereinafter referred to as “LCPO” in some cases) or the like is known as a positive electrode active material that is considered to have a larger theoretical capacity value. Li₂CoP₂O₇ is allowed to contain 2 mol of lithium per molecule at a discharge average potential of 4.9 volts (V), has a large theoretical capacity value, and is expected to serve as a positive electrode active material of a rechargeable battery having high energy density.

However, Li₂CoP₂O₇ has significantly large electronic resistance, which is a cause of internal resistance in the battery operation during charge and discharge, so that there is a problem in achieving high output power of the battery and high use of the positive electrode active material.

An aspect of the present disclosure is to provide a Li₂CoP₂O₇-based positive electrode active material excellent in electronic conductivity, a manufacturing method for the same, and a rechargeable battery using the above positive electrode active material.

### SUMMARY

According to an aspect of the embodiments, a positive electrode active material represented by the composition formula: Li_{2-X}Mg_{X}CoP₂O₇, wherein X is equal to or greater than 0.01 and equal to or smaller than 0.2.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic cross-sectional view illustrating an example of a rechargeable battery;

FIG. 2A is an XRD spectrum of each of positive electrode active materials of Example 1, Example 2, Example 4, and Comparative Example 1;

FIG. 2B is an XRD spectrum of each of positive electrode active materials of Example 1, Example 2, Example 4, Comparative Example 1, and Comparative Example 2;

FIG. 3A is a graph depicting a result of impedance measurement of each of positive electrode active materials in Example 1, Example 2, Example 3, and Comparative Example 1;

FIG. 3B is a graph depicting a result of impedance measurement of each of positive electrode active materials in Example 1, Example 2, Example 3, and Comparative Example 1;

FIG. 4A is a graph depicting a result of impedance measurement of each of positive electrode active materials in Example 3, Example 4, and Comparative Example 1;

FIG. 4B is a graph depicting a result of impedance measurement of each of positive electrode active materials in Example 3, Example 4, and Comparative Example 1;

FIG. 5A is a view depicting a scanning electron micrograph of a cross section of the positive electrode active material of Example 4; and

FIG. 5B is an enlarged view of a range enclosed by a broken line in FIG. 5A.

### DESCRIPTION OF EMBODIMENTS

(Positive Electrode Active Material)

A positive electrode active material according to the disclosure is represented by the composition formula: Li_{2-X}Mg_{X}CoP₂O₇, where X is equal to or greater than 0.01 and equal to or smaller than 0.2.

Li₂CoP₂O₇ has a high theoretical capacity value of 217 milliamp hours/gram (mAh/g), and is expected to be used as a positive electrode active material of a lithium ion rechargeable battery having high energy density. However, Li₂CoP₂O₇ has a significantly large electronic resistance of 10⁻¹² Siemens/centimeter (S/cm), which is a cause of high internal resistance of the battery during charge and discharge, for example. This causes a problem in achieving high output power of the battery and high use of the positive electrode active material (the theoretical capacity of the positive electrode active material is not sufficiently used).

As such, the inventors of the present disclosure conducted intensive studies to improve the electronic conductivity of a positive electrode active material using Li₂CoP₂O₇.

As a result, a positive electrode active material has been found that is represented by the composition formula: Li_{2-X}Mg_{X}CoP₂O₇, where X is equal to or greater than 0.01 and equal to or smaller than 0.2. In this positive electrode active material, by replacing lithium in the crystal structure of Li₂CoP₂O₇ with magnesium at a predetermined ratio, it is possible to increase a space in which U enters, in comparison with the crystal structure of related art formed of only Li₂CoP₂O₇. With this, it has been found that it is possible to improve a diffusion rate of lithium ions and enhance electronic conductivity (decrease resistance) of Li₂CoP₂O₇. In addition, it has been found that, by introducing magnesium into Li₂CoP₂O₇, phases represented by Li_{2-X}Mg_{X}CoP₂O₇ and Li_{5.88}Co_{5.06}(P₂O₇)₄ are formed, so that the resistance of the positive electrode active material is decreased.

In the composition formula of Li_{2-X}Mg_{X}CoP₂O₇ of the disclosed positive electrode active material, the range of x is from 0.01 to 0.2, preferably from 0.05 to 0.2, and more preferably from 0.08 to 0.2. The shape, size, structure, and the like of the disclosed positive electrode active material are not particularly limited, and may be appropriately selected in accordance with the intended purpose. The shape of the positive electrode active material is not particularly limited and may be appropriately selected in accordance with the intended purpose, and a particle form is cited as an example thereof. The particle form includes, for example, a powder form (indeterminate form), a spherical shape, and a rectangular parallelepiped shape. The size of the positive electrode active material is not particularly limited and may be appropriately selected in accordance with the intended purpose; for example, it is preferably equal to or greater than 0.7 micrometers (μm) and equal to or smaller than 1.3 μm in number average particle diameter. When the number average particle diameter of the positive electrode active material is equal to or greater than 0.7 μm and equal to or smaller than 1.3 μm, it is possible to lower the internal resistance of the rechargeable battery, and achieve high output power of the rechargeable battery and high use of the positive electrode active material. A method for adjusting the size of the positive electrode active material is not particularly limited and may be appropriately selected in accordance with the intended purpose, and may include, for example, a method in which the positive electrode active material is pulverized after firing. The pulverizing method is not particularly limited and may be appropriately selected in accordance with the intended purpose. A method for measuring the size of the positive electrode active material is not particularly limited, and may be appropriately selected in accordance with the intended purpose; for example, it may include a method in which observation under a scanning electron microscope is carried out to measure a long axis and a short axis of a certain number or more of particles, and then a number average particle diameter is calculated from the obtained measurement values.

(Manufacturing Method for Positive Electrode Active Material)

The manufacturing method for the disclosed positive electrode active material includes at least a heat treatment process, and further includes a mixing process and other processes as required.

<Heat Treatment Process>

The heat treatment process is a process of heat-treating a mixture. The mixture refers to a mixture of a lithium source, a magnesium source, a cobalt source, and a phosphoric acid source. The method for performing the heat treatment is not particularly limited and may be appropriately selected in accordance with the intended purpose. The heat treatment temperature is not limited to any specific temperature, and may be appropriately selected in accordance with the intended purpose; then, it is preferable to be equal to or higher than 470° C. and equal to or lower than 720° C., and more preferable to be equal to or higher than 500° C. and equal to or lower than 650° C. When the heat treatment temperature is lower than 470° C., the desired crystal structure may not be obtained; when the heat treatment temperature is higher than 720° C., the product may be melted. The heat treatment time is not limited to any specific time, and may be appropriately selected in accordance with the intended purpose; it is preferable to be in a range from one hour to 24 hours, more preferable to be in a range from two hours to 18 hours, and particularly preferable to be in a range from three hours to 15 hours. The heat treatment is preferably performed under an atmosphere of an inert gas. Examples of the atmosphere of the inert gas include an argon atmosphere.

<Mixing Process>

In the mixing process, all the raw materials may be mixed, or a premix may be prepared by mixing two or more raw materials and thereafter the remaining raw materials may be added and mixed, so that an appropriate process may be selected in accordance with the intended purpose.

«First Mode»

The mixing process (first mode) is a process of mixing the raw materials including the lithium source, magnesium source, cobalt source, and phosphoric acid source in a container to obtain the mixture. A tool for mixing the raw materials is not particularly limited and may be appropriately selected in accordance with the intended purpose, and examples thereof include a ball mill. As an example of the ball mill, a planetary ball mill is cited.

An example of the lithium source is a lithium salt. The lithium salt is not particularly limited, and may be appropriately selected in accordance with the intended purpose. Examples of the lithium salt include lithium hydroxide (LiOH), lithium carbonate (Li₂CO₃), lithium nitrate (LiNO₃), lithium sulfate (Li₂SO₄), lithium perchlorate (LiClO₄), lithium hexafluorophosphate (LiPF₆), and lithium tetrafluoroborate (LiBF₄). These lithium salts may be hydrates or anhydrides. In particular, lithium carbonate and lithium nitrate are preferred because a side reaction does not occur. Among these lithium salts, one lithium salt may be used alone, or two or more of them may be simultaneously used.

An example of the magnesium source is a magnesium salt. The magnesium salt is not particularly limited, and may be appropriately selected in accordance with the intended purpose; examples thereof include magnesium oxide, magnesium hydroxide, magnesium carbonate, magnesium oxalate, magnesium acetate, magnesium nitrate, magnesium sulfate, magnesium chloride, and magnesium bromide. These magnesium salts may be hydrates or anhydrides. Among these magnesium salts, one magnesium salt may be used alone, or two or more of them may be simultaneously used.

Examples of the cobalt source include a cobalt salt. The cobalt salt is not limited to any specific one, and may be appropriately selected in accordance with the intended purpose; examples thereof may include cobalt oxide (II), cobalt hydroxide, cobalt carbonate, cobalt oxalate, cobalt acetate, cobalt nitrate, cobalt sulfide, cobalt chloride, cobalt bromide, and cobalt hydroxide (II). These cobalt salts may be hydrates or anhydrides. Among these cobalt salts, one cobalt salt may be used alone, or two or more of them may be simultaneously used.

Examples of the phosphoric acid source include phosphoric acid and phosphate. Examples of the phosphate include ammonium phosphate, ammonium dihydrogen phosphate, and diammonium hydrogen phosphate. These phosphates may be hydrates or anhydrides. Among these phosphates, one phosphate may be used alone, or two or more of them may be simultaneously used.

Instead of the lithium source and the phosphoric acid source, for example, lithium phosphate, dilithium hydrogen phosphate, and lithium dihydrogen phosphate may be used as compounds that serve as the lithium source and phosphoric add source. By using the compounds serving as the lithium source and phosphoric acid source, it is possible to reduce the amounts of raw materials used for the manufacture of the positive electrode active material and to improve the manufacturing efficiency.

The ratio of the lithium source, the magnesium source, the cobalt source, and the phosphoric acid source at the mixing time is not particularly limited, and may be appropriately selected in accordance with the intended purpose; examples of the ratio include a ratio of Li:Mg:Co:P=1.6 or more and 2.0 or less: more than 0 and 0.2 or less: 1.0:2.0 (element ratio, for example, a mol ratio).

The mixing time is not particularly limited, and may be appropriately selected in accordance with the intended purpose. The mixing time is, for example, from one hour to 36 hours. The agitation speed of a tool for mixing the raw materials is not particularly limited, and may be selected in accordance with the intended purpose. The agitation speed is, for example, from 100 rotations per minute (rpm) to 1000 rpm.

«Second Mode»

The mixing process (second mode) is a process in which a premix is prepared by mixing the raw materials including a lithium source, a cobalt source and a phosphoric acid source, and thereafter a magnesium source is mixed with the premix to obtain a mixture. A tool for mixing the raw materials is not particularly limited and may be appropriately selected in accordance with the intended purpose, and examples thereof include a ball mill. As an example of the ball mill, a planetary ball mill is cited.

The lithium source is not particularly limited, and may be appropriately selected in accordance with the intended purpose; examples thereof include the lithium source exemplified in the mixing process (first mode). The magnesium source is not particularly limited, and may be appropriately selected in accordance with the intended purpose; examples thereof include the magnesium source exemplified in the mixing process (first mode). The cobalt source is not particularly limited, and may be appropriately selected in accordance with the intended purpose; examples thereof include the cobalt sources exemplified in the mixing process (first process). The phosphoric add source is not particularly limited, and may be appropriately selected in accordance with the intended purpose; examples thereof include the phosphoric acid source exemplified in the mixing process (first mode).

The ratio of the lithium source, the magnesium source, the cobalt source, and the phosphoric add source is not particularly limited at the mixing time, and may be appropriately selected in accordance with the intended purpose; examples thereof include the ratio exemplified in the first mode.

The mixing time is not particularly limited and may be appropriately selected in accordance with the intended purpose, and examples thereof include the mixing time exemplified in the first mode. The agitation speed of a tool for mixing the raw materials is not particularly limited and may be appropriately selected in accordance with the intended purpose, and examples thereof include the agitation speed exemplified in the first mode.

<Other Processes>

Other processes are not particularly limited, and may be appropriately selected in accordance with the intended purpose; a pulverizing process is cited as an example. The pulverizing process is a process of pulverizing a positive electrode active material having been subjected to heat treatment and firing. A tool for pulverizing the positive electrode active material having been subjected to heat treatment and firing is not particularly limited, and may be appropriately selected in accordance with the intended purpose; a pulverizer is cited as an example thereof. A commercially available product may be used as the pulverizer. As a commercially available product, for example, MG4A, which is a pulverizer manufactured by Ito Seisakusho Co., Ltd., is cited.

(Rechargeable Battery and Manufacturing Method for the Same)

The disclosed rechargeable battery includes at least the disclosed positive electrode active material, and further includes other members as required. A manufacturing method for the disclosed rechargeable battery is a method of manufacturing the rechargeable battery, the method including a manufacturing method for the disclosed positive electrode active material, and further including other processes as required.

The rechargeable battery of the present disclosure uses a Li₂CoP₂O₇-based positive electrode active material excellent in electronic conductivity.

For example, the rechargeable battery includes at least a positive electrode, and further includes, as required, a negative electrode, an electrolyte, a separator, a positive electrode case, a negative electrode case, and other members.

«Positive Electrode»

The positive electrode includes at least the disclosed positive electrode active material, and further includes other members such as a positive electrode current collector as required.

The content of the positive electrode active material in the positive electrode is not particularly limited, and may be appropriately selected in accordance with the intended purpose. In the positive electrode, the positive electrode active material may be mixed with a conductive material and a binder material to form a positive electrode layer. The conductive material is not particularly limited, and may be appropriately selected in accordance with the intended purpose; as an example of the conductive material, a carbon-based conductive material is cited. Examples of the carbon-based conductive material include acetylene black and carbon black. The binder material is not particularly limited, and may be appropriately selected in accordance with the intended purpose. Examples of the binder material include polytetrafluoroethylene (PTFE), polyvinylidene fluoride (PVDF), ethylene-propylene-butadiene rubber (EPBR), styrene-butadiene rubber (SBR), and carboxymethyl cellulose (CMC).

The material, size, and structure of the positive electrode are not particularly limited, and may be appropriately selected in accordance with the intended purpose. The shape of the positive electrode is not particularly limited and may be appropriately selected in accordance with the intended purpose, and may include, for example, a rod form or a disk form.

—Positive Electrode Current Collector—

The shape, size, and structure of the positive electrode current collector are not particularly limited, and may be appropriately selected in accordance with the intended purpose. The material for the positive electrode current collector is not particularly limited, and may be appropriately selected in accordance with the intended purpose. Examples of the material for the positive electrode current collector include stainless steel, aluminum, copper, and nickel.

The positive electrode current collector is used to make the positive electrode layer achieve good electrical conductivity with respect to the positive electrode case serving as a terminal.

«Negative Electrode»

The negative electrode includes at least a negative electrode active material, and further includes, as required, other members such as a negative electrode current collector.

The size and structure of the negative electrode are not particularly limited, and may be appropriately selected in accordance with the intended purpose. The shape of the negative electrode is not particularly limited and may be appropriately selected in accordance with the intended purpose, and may include, for example, a rod form or a disk form.

—Negative Electrode Active Material—

The negative electrode active material is not particularly limited, and may be appropriately selected in accordance with the intended purpose. As an example of the negative electrode active material, a compound containing an alkali metal element is cited. Examples of the compound containing an alkali metal element include elemental metals, alloys, metal oxides, and metal nitrides. An example of the alkali metal element is lithium. An example of the elemental metal is lithium. An example of the alloy is an alloy containing lithium. Examples of the alloy containing lithium include a lithium-aluminum alloy, a lithium-tin alloy, a lithium-lead alloy, and a lithium-silicon alloy. An example of the metal oxide is a metal oxide containing lithium. An example of the metal oxide containing lithium is lithium titanium oxide. An example of the metal nitride is a metal nitride containing lithium. Examples of the metal nitride containing lithium include lithium cobalt nitride, lithium iron nitride, and lithium manganese nitride.

The content of the negative electrode active material in the negative electrode is not particularly limited, and may be appropriately selected in accordance with the intended purpose.

In the negative electrode, the negative electrode active material may be mixed with a conductive material and a binder material to form a negative electrode layer. The conductive material is not particularly limited, and may be appropriately selected in accordance with the intended purpose; as an example of the conductive material, a carbon-based conductive material is cited. Examples of the carbon-based conductive material include acetylene black and carbon black. The binder material is not particularly limited, and may be appropriately selected in accordance with the intended purpose. Examples of the binder material include polytetrafluoroethylene (PTFE), polyvinylidene fluoride (PVDF), ethylene-propylene-butadiene rubber (EPBR), styrene-butadiene rubber (SBR), and carboxymethyl cellulose (CMC).

—Negative Electrode Current Collector—

The shape, size, and structure of the negative electrode current collector are not particularly limited, and may be appropriately selected in accordance with the intended purpose. The material for the negative electrode current collector is not particularly limited, and may be appropriately selected in accordance with the intended purpose. Examples of the material for the negative electrode current collector include stainless steel, aluminum, copper, and nickel.

The negative electrode current collector is used to make the negative electrode layer achieve good electrical conductivity with respect to the negative electrode case serving as a terminal.

«Electrolyte»

The electrolyte is not particularly limited, and may be appropriately selected in accordance with the intended purpose. Examples of the electrolyte include a nonaqueous electrolytic solution and a solid electrolyte.

—Nonaqueous Electrolytic Solution—

Examples of the nonaqueous electrolytic solution include a nonaqueous electrolytic solution containing a lithium salt and an organic solvent.

—Lithium Salt—

The lithium salt is not particularly limited, and may be appropriately selected in accordance with the intended purpose. Examples of the lithium salt include lithium hexafluorophosphate, lithium tetrafluoroborate, lithium perchlorate, lithium bis (pentafluoroethanesulfone) imide, and lithium bis (trifluoromethanesulfone) imide. Among these lithium salts, one lithium salt may be used alone, or two or more of them may be simultaneously used.

The concentration of the lithium salt in the organic solvent is not particularly limited and may be appropriately selected in accordance with the intended purpose, and it is preferable that the concentration be equal to or higher than 0.5 mol per liter (mol/L) and equal to or lower than 3 mol/L in terms of ionic conductivity.

—Organic Solvent—

The organic solvent is not particularly limited, and may be appropriately selected in accordance with the intended purpose. Examples of the organic solvent include ethylene carbonate, dimethyl carbonate, propylene carbonate, diethyl carbonate, and ethyl methyl carbonate. Among these organic solvents, one organic solvent may be used alone, or two or more of them may be simultaneously used.

The content of the organic solvent in the nonaqueous electrolytic solution is not particularly limited, and may be appropriately selected in accordance with the intended purpose; the content of the organic solvent is preferably equal to or greater than 75 mass % and equal to or smaller than 95 mass %, and more preferably equal to or greater than 80 mass % and equal to or smaller than 90 mass %. In the case where the content of the organic solvent is smaller than 75 mass %, the viscosity of the nonaqueous electrolytic solution increases and the wettability thereof with respect to the electrodes decreases, which may increase the internal resistance of the battery. In the case where the content of the organic solvent is greater than 95 mass %, the ionic conductivity decreases, which may reduce the output power of the battery. On the other hand, when the content of the organic solvent falls within the more preferable range, an advantage is achieved in a point that it is possible to maintain high ionic conductivity, and to maintain the wettability with respect to the electrodes by suppressing the viscosity of the nonaqueous electrolytic solution.

—Solid Electrolyte—

The solid electrolyte is not particularly limited, and may be appropriately selected in accordance with the intended purpose. Examples of the solid electrolyte include an inorganic solid electrolyte and a solvent-free polymer electrolyte. Examples of the inorganic solid electrolyte include a lithium super ionic conductor (LISICON) material and a perovskite material. An example of the solvent-free polymer electrolyte is a polymer having an ethylene oxide bond.

The content of the electrolyte in the rechargeable battery is not particularly limited, and may be appropriately selected in accordance with the intended purpose.

«Separator»

The material for the separator is not particularly limited, and may be appropriately selected in accordance with the intended purpose. Examples of the material for the separator include paper, cellophane, polyolefin nonwoven fabric, polyamide nonwoven fabric, and glass fiber nonwoven fabric. Examples of the paper include kraft paper, vinylon mixed paper, and synthetic pulp mixed paper. The shape of the separator is not particularly limited and may be appropriately selected in accordance with the intended purpose, and examples thereof include a sheet form. The separator may have a single-layer structure or a multilayer structure. The size of the separator is not particularly limited, and may be appropriately selected in accordance with the intended purpose.

«Positive Electrode Case»

The material for the positive electrode case is not particularly limited, and may be appropriately selected in accordance with the intended purpose. Examples of the material for the positive electrode case include copper, stainless steel, and a metal in which stainless steel or iron is plated with nickel or the like. The shape of the positive electrode case is not particularly limited, and may be appropriately selected in accordance with the intended purpose. Examples of the shape of the positive electrode case include a shallow dish-like shape with its circumference curved upward, a cylindrical shape with a closed bottom, and a prismatic shape with a closed bottom. The positive electrode case may have a single-layer structure or a multilayer structure. The multilayer structure is, for example, a three-layer structure constituted by nickel, stainless steel, and copper. The size of the positive electrode case is not particularly limited, and may be appropriately selected in accordance with the intended purpose.

«Negative Electrode Case»

The material for the negative electrode case is not particularly limited, and may be appropriately selected in accordance with the intended purpose. Examples of the material for the negative electrode case include copper, stainless steel, and a metal in which stainless steel or iron is plated with nickel or the like. The shape of the negative electrode case is not particularly limited, and may be appropriately selected in accordance with the intended purpose. Examples of the shape of the negative electrode case include a shallow dish-like shape with its circumference curved upward, a cylindrical shape with a closed bottom, and a prismatic shape with a closed bottom. The negative electrode case may have a single-layer structure or a multilayer structure. The multilayer structure is, for example, a three-layer structure constituted by nickel, stainless steel, and copper. The size of the negative electrode case is not particularly limited, and may be appropriately selected in accordance with the intended purpose.

The shape of the rechargeable battery is not particularly limited and may be appropriately selected in accordance with the intended purpose. Examples of the shape of the rechargeable battery include a coin-like shape, a cylindrical shape, a rectangular shape, and a sheet-like shape.

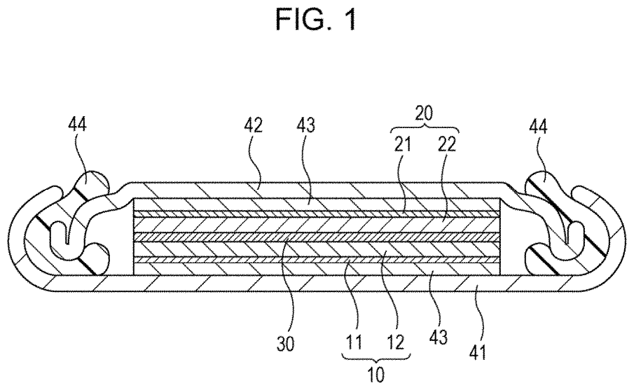

An example of the disclosed rechargeable battery will be described with reference to the drawings. FIG. 1 is a schematic cross-sectional view illustrating an example of the disclosed rechargeable battery. The rechargeable battery illustrated in FIG. 1 is a coin-shaped lithium ion rechargeable battery. The coin-shaped lithium ion rechargeable battery includes a positive electrode 10 including a positive electrode current collector 11 and a positive electrode layer 12, a negative electrode 20 including a negative electrode current collector 21 and a negative electrode layer 22, and an electrolyte layer 30 interposed between the positive electrode 10 and the negative electrode 20. In the rechargeable battery in FIG. 1, the positive electrode current collector 11 is fixed to a positive electrode case 41 with a current collector 43 interposed therebetween, and the negative electrode current collector 21 is fixed to a negative electrode case 42 with another current collector 43 interposed therebetween. A space between the positive electrode case 41 and the negative electrode case 42 is sealed with, for example, a packing material 44 made of polypropylene. The current collectors 43 are used to achieve electrical conductivity between the positive electrode current collector 11 and the positive electrode case 41 while filling a gap between the positive electrode current collector 11 and the positive electrode case 41, and between the negative electrode current collector 21 and the negative electrode case 42 while filling a gap between the negative electrode current collector 21 and the negative electrode case 42, respectively. The positive electrode layer 12 is prepared by using a positive electrode material for the disclosed rechargeable battery.

### EXAMPLES

Hereinafter, examples of the disclosed techniques will be described, but the disclosed techniques are not limited to the following examples. The raw materials used in the examples, comparative examples, and reference examples were obtained from the following companies.

Li₂CO₃: Kojundo Chemical Laboratory Co., Ltd.

(NH₄)₂HPO₄: Kanto Chemical Co., Inc.

CoC₂O_{4′}2H₂O: Junsel Chemical Co., Ltd.

Magnesium Oxide (MgO): Kojundo Chemical Laboratory Co., Ltd.

### Example 1

### <Preparation of Positive Electrode Active Material 1>

As the raw materials of a positive electrode active material 1, 1.4816 g of Li₂CO₃, 5.3497 g of (NH₄)₂HPO₄, 3.7062 g of CoC₂O_{4′}2H₂O, and 0.0082 g of MgO were put in a zirconia pot. The zirconia pot was disposed in a ball mill device, and the ball mill device was driven at 400 rpm for 48 hours to mix the raw materials of the positive electrode active material 1. The mixed raw materials of the positive electrode active material 1 were molded into a pellet, and then the pellet was fired at 600° C. for 12 hours under an argon atmosphere, whereby the positive electrode active material 1 was prepared.

### Examples 2 to 4 and Comparative Examples 1 and 2

### <Preparation of Positive Electrode Active Materials 2 to 6>

Positive electrode active materials 2 to 6 were prepared in the same manner as the positive electrode active material 1 of Example 1 except that the raw materials and their blending amounts (g) of the positive electrode active material 1 In Example 1 were changed to the raw materials and their blending amounts (g) of the positive electrode active materials 2 to 6 as described in Table 1.

TABLE 1

| | | EXAM. | EXAM. | EXAM. | EXAM. | COMP. | COMP. |
|---|---|---|---|---|---|---|---|
| | | 1 | 2 | 3 | 4 | EXAM. 1 | EXAM. 2 |
| | | POSITIVE ELECTRODE ACTIVE MATERIAL No. | | | | | |
| | | 1 | 2 | 3 | 4 | 5 | 6 |
| RAW | Li₂CO₃ (g) | 1.4816 | 1.4194 | 1.3418 | 1.1877 | 1.4972 | 1.0345 |
| MATERIALS | (NH₄)₂HPO₄ (g) | 5.3497 | 5.3406 | 5.3294 | 5.3071 | 5.3519 | 5.285 |
| | CoC₂O₄•2H₂O (g) | 3.7062 | 3.6999 | 3.6921 | 3.6767 | 3.7077 | 3.6613 |
| | MgO (g) | 0.0082 | 0.0407 | 0.0813 | 0.162 | 0 | 0.2419 |

| | | | | | | |
|---|---|---|---|---|---|---|
| VALUE OF x IN Li₂₋ₓMgₓCoP₂O₇ | 0.01 | 0.05 | 0.1 | 0.2 | 0 | 0.3 |

In Table 1, EXAM. Means EXAMPLE, and COMP. means COMPARABLE.

<Crystal Structure Analysis>

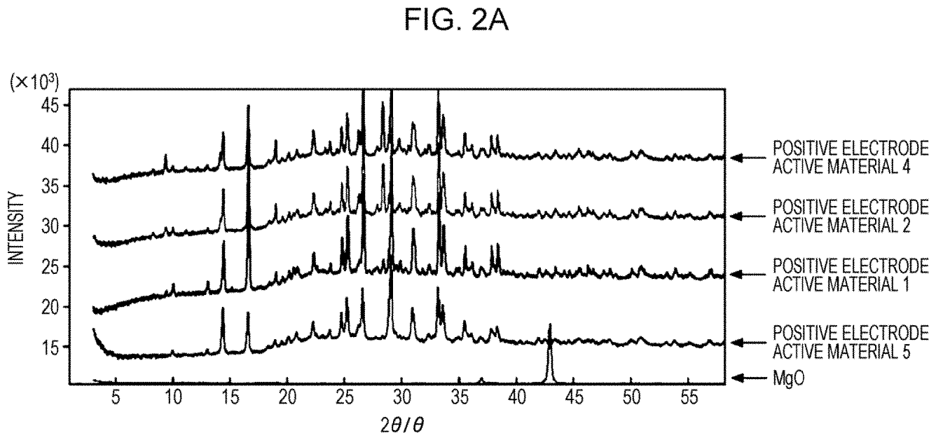

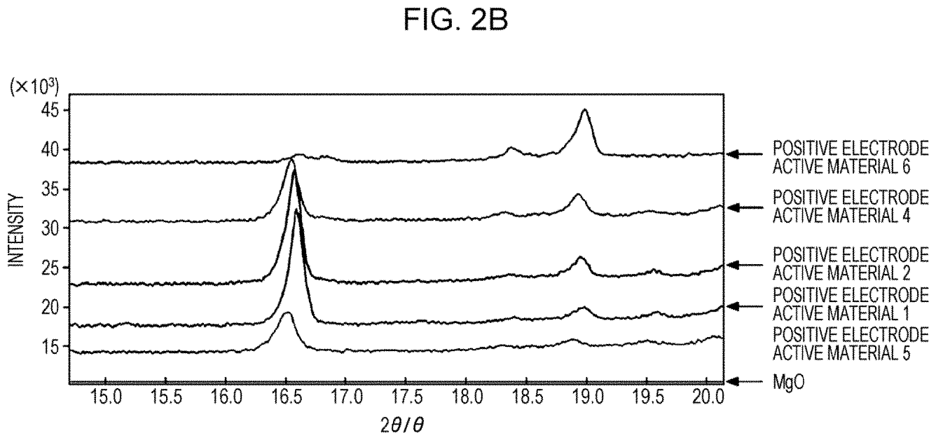

In order to analyze crystal structures of the positive electrode active materials 1, 2, 4, and 5 obtained in Examples 1, 2, and 4, and Comparative Example 1, powder X-ray diffraction measurement was carried out by using a desktop powder X-ray diffractometer (apparatus name: Rigaku, Miniflex 600). XRD spectra obtained in the measurement (by Cu-Kα characteristic X-ray) are depicted in FIG. 2A. Since diffraction peaks unique to the crystal structure appeared in each of the positive electrode active materials 1, 2, 4, and 5, it was confirmed that each of the positive electrode active materials 1, 2, 4, and 5 had a crystal structure. The positive electrode active materials 1, 2, 4, and 5 obtained in Examples 1, 2, and 4, and Comparative Example 1 exhibited substantially the same diffraction profile. Since the positive electrode active materials 1, 2, 4, and 5 did not exhibit a diffraction peak similar to a diffraction peak of MgO alone (a diffraction peak at 2θ/θ=40 to 45) illustrated at the bottom of the graph, it was confirmed that MgO did not remain in the positive electrode active materials 1, 2, 4, and 5.

FIG. 28 illustrates an enlarged view in a range of 2θ/θ=15 to 20 in FIG. 2A. In FIG. 2B, a measurement result of the positive electrode active material 6 obtained in Comparative Example 2 is depicted in addition to the measurement results of the positive electrode active materials 1, 2, 4, and 5 obtained in Examples 1, 2, and 4, and Comparative Example 1. The crystal phase of a diffraction peak (diffraction peak of the positive electrode active material 5) appearing in the range of 2θ/θ=16 to 17 in FIG. 2B was identified by using the database of International Centre for Diffraction Data (Powder Diffraction File, hereinafter referred to as “PDF database”). As a result, it was found to be the Li₂CoP₂O₇ crystal phase (JCPDS card No. 01-080-7757). As depicted in FIG. 2B, diffraction peaks appearing in the range of 2θ/θ=16 to 17 of the positive electrode active materials 1, 2, and 4 were shifted to the right as compared with the diffraction peak appearing in the range of 2θ/θ=16 to 17 of the positive electrode active material 5. This meant that magnesium was introduced into the Li₂CoP₂O₇ crystal. In the positive electrode active material 6 In which magnesium was prepared so that x was equal to 0.3, the diffraction peak of the Li₂CoP₂O₇ crystal phase appearing in the range of 2θ/θ=16 to 17 disappeared, and the diffraction peak was shifted to fall within a range of 2θ/θ=18.5 to 19.5. The crystal phase at this position was identified by using the PDF database, and was consequently found to be the Li₆Co₅(P₂O₇)₄ crystal phase (JCPDS card No. 01-080-7757). That is, it was found that, when “x” in the composition formula Li₂₋ₓMgₓCoP₂O₇ was 0.3 or more, a positive electrode active material having the crystal phase of Li₂₋ₓMgₓCoP₂O₇ was unable to be obtained.

<Impedance Measurement>

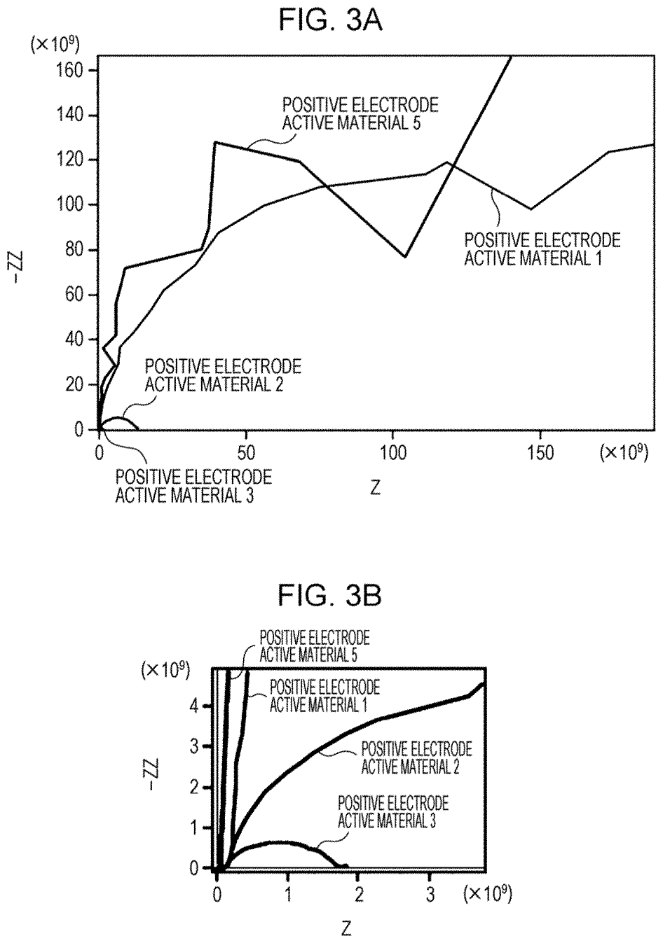

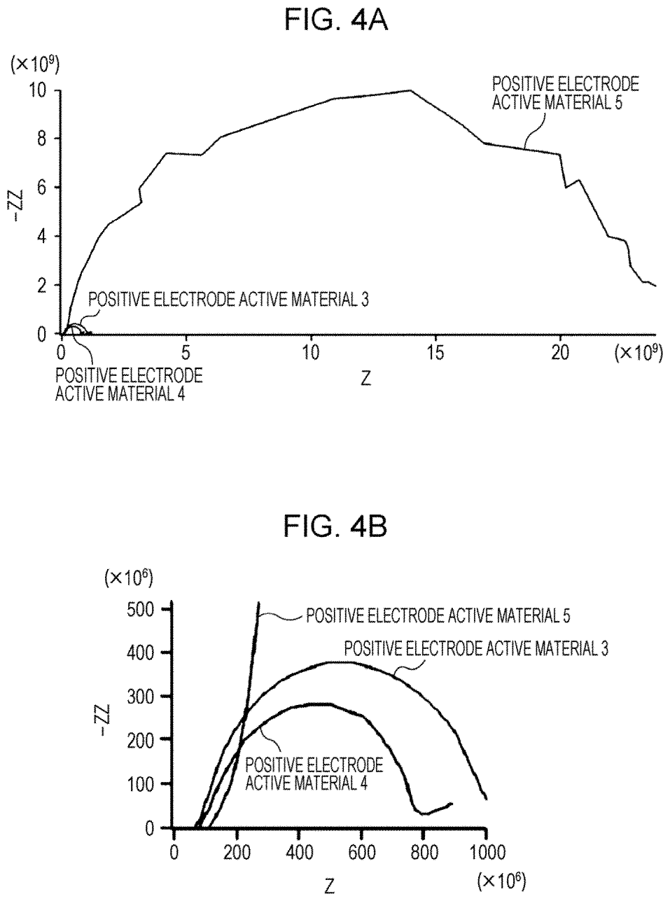

Each of the positive electrode active materials 1 to 5 was molded into a pellet having a diameter of 10±1 mm, a thickness of 3.4±1 mm, and a weight of 0.4±0.2 g. A voltage of 2000 mV was applied to each pellet in a range from 7 MHz to 100 MHz to perform current response by an AC impedance method, and the measurement results were plotted. The impedance measurement was carried out in an environment under a dry argon flow at 300° C. As an evaluation apparatus, used was a frequency response analysis apparatus incorporated in the VMP-300 multichannel electrochemical measurement system, manufactured by Bio-Logic Science Instruments. The impedance measurement results of the positive electrode active materials 1 to 3 and 5 are depicted in FIG. 3A and FIG. 3B, and the impedance measurement results of the positive electrode active material 3 to 5 are depicted in FIG. 4A and FIG. 4B. In each of the graphs illustrated in FIG. 3A to FIG. 4B, the vertical axis represents an imaginary component of complex impedance, and the horizontal axis represents a real component of the complex impedance. It is meant that, as the size of an arc drawn in the graph is smaller, the resistance is smaller (improvement in electrical conductivity is achieved). As illustrated in FIG. 3A to FIG. 4B, it was found that the impedance of Li₂CoP₂O₇ was decreased by increasing the amount of magnesium introduced into Li₂CoP₂O within a set range. That is, it was found that the electronic conductivity of Li₂CoP₂O₇ was able to be improved (resistance is decreased) with the increase of the amount of magnesium introduced.

<Scanning Electron Microscope Observation>

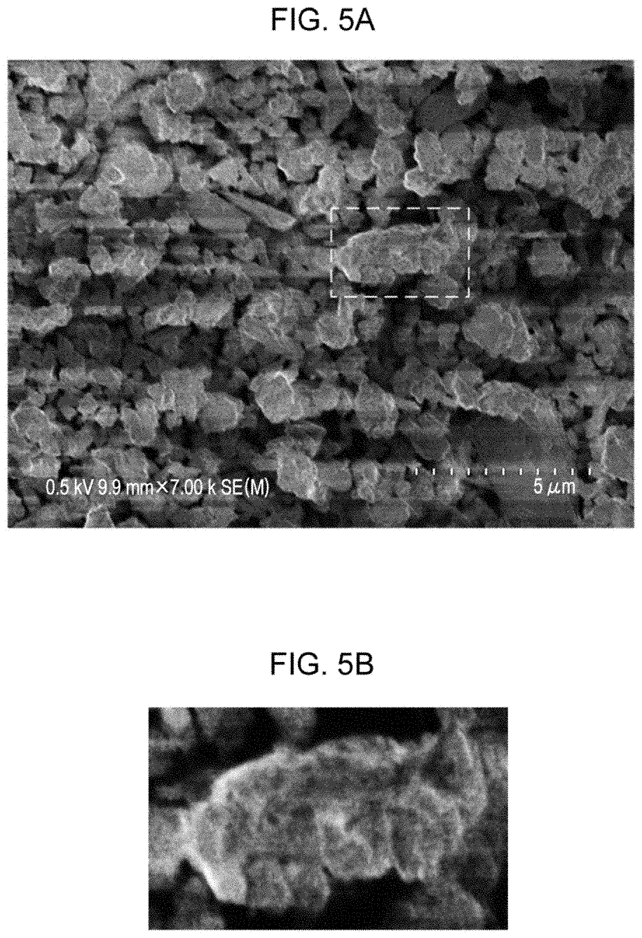

In order to confirm a surface state of the obtained positive electrode active material 4, observation was carried out by using a scanning electron microscope (apparatus name: SEM S-4800, manufactured by Hitachi, Ltd.) at an acceleration voltage of 0.5 kV and a measurement magnification of 7000 times. The results are depicted in FIG. 5A and FIG. 5B. FIG. 5B gives an enlarged view of a range enclosed by a broken line in FIG. 5A. As depicted in FIG. 5A and FIG. 5B, it was observed that the surface of the positive electrode active material 4 was a coagulation body in which particles having a number average particle diameter of about 1 μm were coagulated. Since the surface is a coagulation body in which particles of the positive electrode active material having the number average particle diameter of about 1 μm were coagulated, it is possible to lower the internal resistance of the rechargeable battery, and it may be expected to achieve high output power of the rechargeable battery.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A positive electrode active material comprising:
lithium, magnesium, cobalt, and phosphoric acid and represented by composition formula:
Li_{2-X}Mg_{X}CoP₂O₇
wherein X is equal to or greater than 0.01 and equal to or smaller than 0.2.

2. The positive electrode active material according to claim 1, wherein the X is equal to or greater than 0.08 and equal to or smaller than 0.2.

3. The positive electrode active material according to claim 1, wherein a number average particle diameter is equal to or greater than 0.7 μm and equal to or smaller than 1.3 μm.

4. A method of manufacturing a positive electrode active material comprising lithium, magnesium, cobalt, and phosphoric acid and represented by composition formula: Li_{2-X}Mg_{X}CoP₂O₇ in which X is equal to or greater than 0.01 and equal to or smaller than 0.2, the method comprising:
heat-treating a mixture of a lithium source, a magnesium source, a cobalt source, and a phosphoric acid source.

5. The method of manufacturing the positive electrode active material according to claim 4, wherein
a temperature when the heat-treating is performed is from 470° C. to 720° C.

6. The method of manufacturing the positive electrode active material according to claim 4, wherein
the lithium source is a lithium salt.

7. The method of manufacturing the positive electrode active material according to claim 4, wherein
the magnesium source is a magnesium salt.

8. The method of manufacturing the positive electrode active material according to claim 4, wherein
the cobalt source is a cobalt salt.

9. The method of manufacturing the positive electrode active material according to claim 4, wherein
the phosphoric add source is a phosphate.

10. The method of manufacturing the positive electrode active material according to claim 4, wherein
the lithium source and the phosphoric acid source are compounds serving as the lithium source and the phosphoric acid source.

11. A rechargeable battery comprising:
a positive electrode containing a positive electrode active material comprising lithium, magnesium, cobalt, and phosphoric acid and represented by composition formula: Li_{2-X}Mg_{X}CoP₂O₇ in which X is equal to or greater than 0.01 and equal to or smaller than 0.2;
a negative electrode; and
an electrolyte disposed between the positive electrode and the negative electrode.

12. The rechargeable battery according to claim 11, wherein
the electrolyte is a solid electrolyte.
